(19) United States
(12) Patent Application Publication
(10) Pub. No.: US 2006/0182484 A1
(43) Pub. Date: Aug. 17, 2006

(54) Printing methods, folding methods, and packaging methods for album photo covers

(75) Inventors: Boping Xie, Irvine, CA (US); Rodrigo Catalan, Pacific Palisades, CA (US); Jun Sugiyama, Suwa City (JP)

Correspondence Address: PILLSBURY WINTHROP SHAW PITTMAN LLP, P.O BOX 10500, McLean, VA, 22102, US

(73) Assignee: EPSON AMERICA, INC., Long Beach, CA (US)

(21) Appl. No.: 11/056,043

(22) Filed: Feb. 11, 2005

(51) Int. Cl. B41J 15/08

(52) U.S. Cl. 400/619

(57) ABSTRACT

A photo album creating or editing software application transfers a total cover page image to a printer. The total cover page image may include printer commands or printer commands may be transmitted separately. The total cover page image is transferred separately or is transferred in sections, such as a back flap section, a back cover section, a spine section, a front cover section, and a front flap section. The printer receives an indication that a printhead is approaching a fold area of the cover page paper. The printer moves the printhead in response to receiving the indication that the printhead is approaching a fold area. The printer forwards the cover page paper by a pre-determined amendment. The printhead of the printer resumes printing, after the forwarding of the cover page paper.

### BACKGROUND

1. Technical Field

Embodiments of this invention relate generally to printing on bent-processed ink-jet paper, marking score lines on bent-processed ink-jet paper, and packaging bent-processed ink-jet paper. Specifically, the invention relates to printing on a cover page paper, making score lines on a cover page paper, and packaging cover page paper.

2. Discussion of the Related Art

A large market is developing in the electronic generation of photo albums and electronic photobooks, such as electronic scrapbooks. In order to personalize and professionalize these albums and books, the photo albums and electronic scrapbooks may include covers. These album covers may be printed on ink-jet or laser printers. Two representative sizes of these albums are 20.87 inches by 5.5 inches and 28.73 inches by 8.5 inches. The album covers or album cover pages may have standard heights but larger widths because the album covers include a front flap, a back flap, a front cover, an album spine, and a back cover.

The larger width of cover page paper (or album/book covers) presents challenges for shipping the cover page paper, printing on the cover page paper, and folding or scoring of the cover page paper. In regard to shipping the cover page paper, if the paper is not folded, then the shipping package will be irregular or long. This results in higher shipping costs and requires more shelf space in a retail outlet. Accordingly, a need exists for a way to ship cover page paper in a more standard size or smaller-size paper size box.

When making scoring lines (fold lines) on cover page paper, specifically paper with a silica coating, top layers of the cover page paper will rip, crack, or tear. Specifically, an ink receiving layer (on which the ink is printed) of the ink jet paper may be cracked when scoring the cover page paper. Accordingly, a need exists for a method of scoring lines between the front flap and the front cover and the back flap and the back cover that does not crack or damage the two layers and provides for a longer lasting and professional looking cover page.

When an inkjet printer prints on a cover page, the bending area of the cover page may result in a printhead of the printer touching the cover page or cover paper. The platen gap (the distance between the platen roller and the printhead) may be 0.5 millimeters (mm) to 2.0 mm in width. FIGS. 1(a) and 1(b) illustrate a top view of a printing system and a side view of a printer according to the prior art. FIG. 1 (b) illustrates the platen gap. The deformation (or bend length) of the cover page paper may greater than the platen gap and this may result in the printhead hitting the cover page paper. This may result in blotting or printing a portion of an image on the area around the fold line which results in an unprofessional appearance of the cover page paper. Accordingly, a need exists for a printing method that prevents a printhead from printing in an area of the cover page surrounding the fold lines.

### BRIEF DESCRIPTION OF THE DRAWINGS

FIGS. 1(a) and 1(b) illustrate a top view of a printing system and a side view of a printer according to the prior art;

FIG. 2 illustrates a flowchart of a printing process according to an embodiment of the invention;

FIG. 2(b) illustrates a cover page for an album according to an embodiment of the present invention;

FIG. 3(a) illustrates a print selection screen according to an embodiment of the present invention;

FIG. 3(b) illustrates operating conditions where a front cover is selected for placement of images and/or text;

FIG. 3(c) illustrates a sample fully printed cover page according to an embodiment of the present invention;

FIG. 4 illustrates a method to minimize marking or printing in fold areas of the cover page according to an embodiment of the present invention;

FIG. 5 illustrates a top view of scoring of a cover page according to an embodiment of the present invention;

FIG. 6 illustrates a cross section of cover page paper utilized for high-quality ink jet printing according to an embodiment of the present invention;

FIGS. 7(a), 7(b), and 7(c) illustrate side views of elements utilized in creating score lines or fold lines according to an embodiment of the present invention;

FIGS. 8(a) and 8(b) illustrate side views of two systems for scoring photographic paper according to an embodiment of the present invention;

FIG. 8(c) illustrates a top view of a single page resting on a system table after having score lines generated according to an embodiment of the present invention;

FIG. 8(d) illustrates a top view of a plurality of pages resting on a system table after having score lines generated according to an embodiment of the present invention;

FIG. 9 illustrates packaging of a plurality of sheets of cover page paper according to an embodiment of the present invention;

FIG. 10(a) illustrates a side view of a cover page support portion according to an embodiment of the present invention;

FIG. 10(b) illustrates a side view of a cover page support portion where a semi-circular portion is only connected to a cover page support portion at a single side according to an embodiment of the invention; and

FIG. 10(c) illustrates a top view of a cover page support portion including perforated lines in the semi-circular support portion according to an embodiment of the present invention

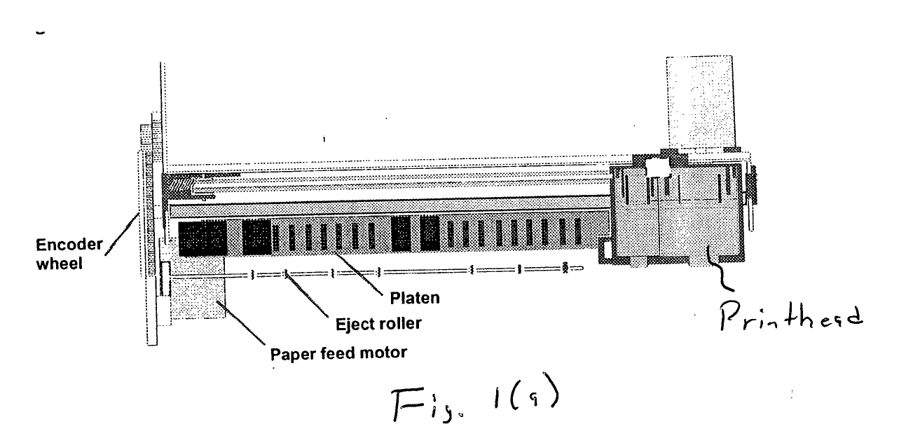

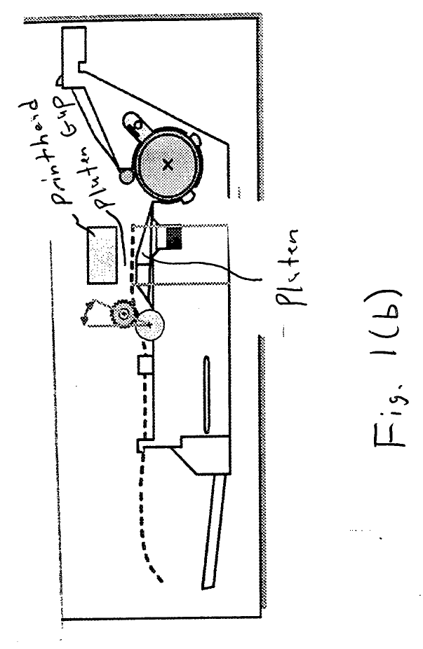

### DETAILED DESCRIPTION

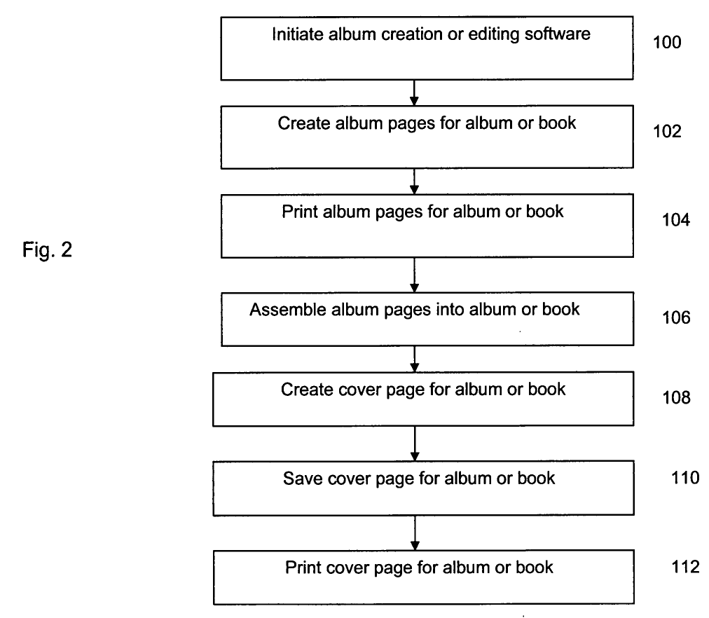

FIG. 2 illustrates a flowchart of a printing process according to an embodiment of the invention. An album editing or creation software, such as Epson Storyteller™ may be initiated 100 on a computing device. The album may be a photo album, a scrapbook album, a yearbook, a textbook, or other albums which include a cover page where the cover page may include images.

The album core or pages of the album may be created 102, may be printed 104, and bound or assembled 106 into a photo book kit. The album editing or creation software may allow for creation or generation 108 of a cover page. Discussion of the creation and printing of the photo book kit and photo book covers are detailed in U.S. patent application Ser. No. 10/995,651, filed Nov. 23, 2004, entitled “Personal Photo Book Creation Kit,” and also in U.S. patent application Ser. No. ______, Attorney Docket No. 81223-0314863, filed concurrently herewith. Both of these applications are incorporated by reference.

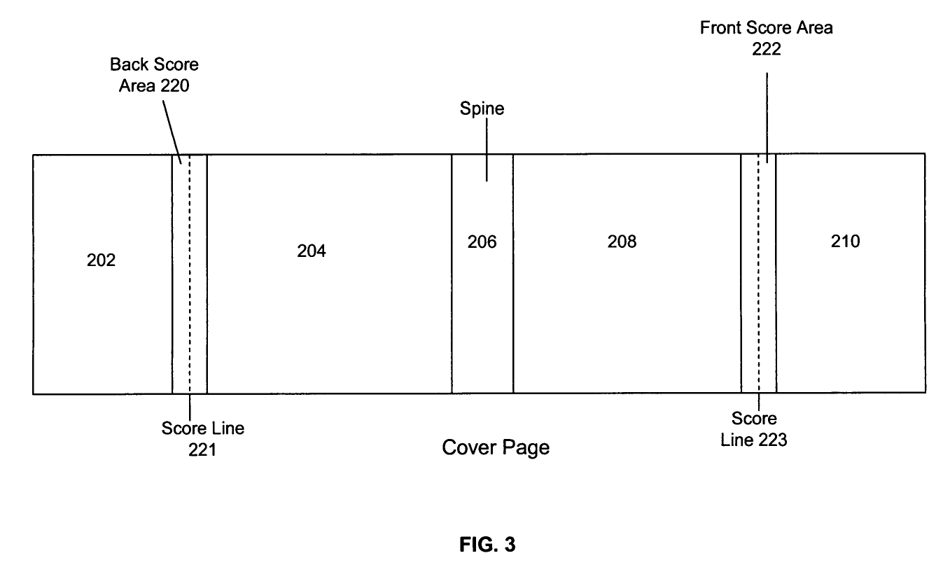

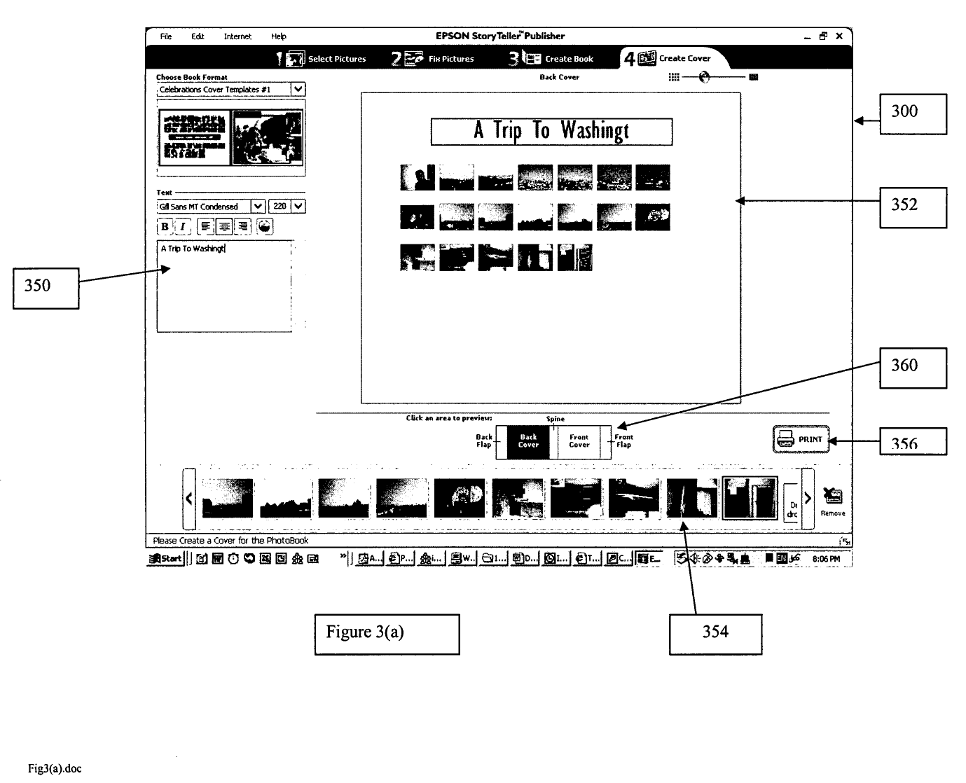

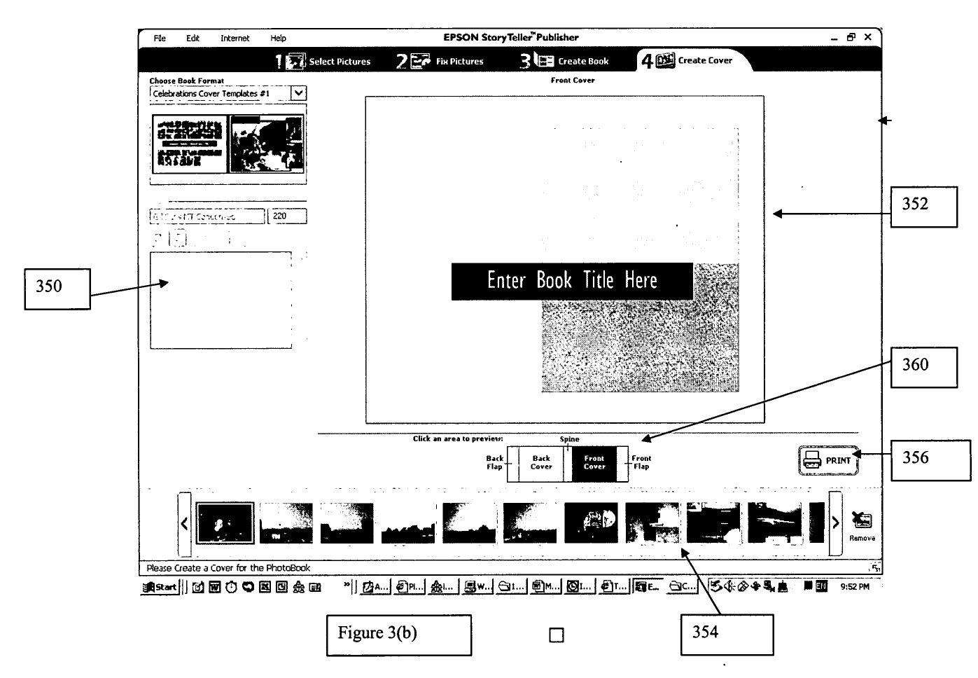

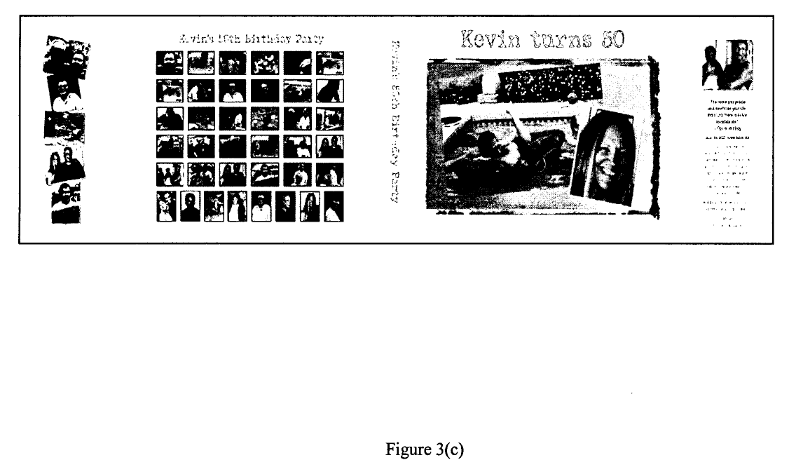

FIG. 3 illustrates a cover page for an album according to an embodiment of the present invention. An album cover page may include separate sections including a back flap 202, a back cover 204, a spine 206, a front cover 208, and a front flap 210. The album editing or creation software may create separate images for each of the separate sections. The images may be a single color image, a pattern, or a background image with photos or images embedded. The album editing or creation software allows selection on one of the sections and the photos or images can be manipulated or rearranged within that section. The cover page may be saved 110 into a memory (either volatile or non-volatile) of a computing device that the album editing or creation software is being executed or run on.

The cover page may be printed 112. In other words, a total cover page image (including the images for each of the cover page sections) may be printed. FIG. 3(a) illustrates a print selection screen according to an embodiment of the present invention. After the cover page has been created and printing has been selected, the images for each section of the cover page are transferred from a computing device to a printer. Under certain operating conditions, a printer driver (resident within the computing device) controls the transfer from the computing device to the printer of the images for each section, e.g., the total cover page image. In other words, the printer driver translates the total cover page image into a format that is understandable for the printer. Including with the total cover page image are commands, understandable by the printer, that identify that different actions that may be taken by the printer. Illustrative commands may be carriage return due to end of line, move printhead to left or right, advance paper a set number of lines, etc.

Under certain operating conditions, the total cover page image and commands may be transferred together. Under other operating conditions, the total cover page image and commands may be transferred in separate files. Under certain operating conditions, each section of the total cover page image may be transmitted separately. Under this operating condition, the commands may be transmitted separately and may be interspersed in between the sections of the cover page image. The printer receives the total cover page image along with printer commands and may store this information in a buffer or spooler. The buffer or spooler may be a memory resident on a separate board in the printer or may be a memory on a printer controller board in the printer. The printer controller board, when the printer is available, receives the total cover page image and printer commands, initializes the printer according to the printer commands transferred from the album creation and editing software, and prints the cover page in accordance with the total cover page image. In embodiments of the invention where sections of the total cover page image are transferred one at a time, a first section is transferred and stored in the print spooler. The second section of the total cover page image starts to be transferred while the printer begins printing the first section of the total cover page image. This continues to occur until all of the sections have been transferred to the spooler in the printer.

In between the back flap 202 and the back cover page 204 and the front flap 210 and the front cover page 208 are a back fold area 220 and a front fold area 222, respectively. FIG. 2(b) illustrates a back fold area 220 and a front fold area 222 on a cover page according to an embodiment of the present invention. In embodiments of the invention, the cover page may include a first fold or score line 221 in the back fold area 220 and a second fold or score line 223 in the front fold area 222. As discussed above, the rise or increase in height of the back fold area 220 and the front fold area 222, due to the presence of the first fold line 221 and the second fold line 223, may cause the cover page paper to touch the printhead and to leave a mark on the cover page paper. This mark may be printed in the area of the front fold area 222 or the back fold area 220. Additionally, contact between the printhead in the front fold area 222 or the back fold 220 area may cause the progression of the cover page paper or the forwarding of the cover page paper to be impeded and the cover page may lose its alignment. This may result in images not being printed in a proper alignment in the designated section of the cover page.

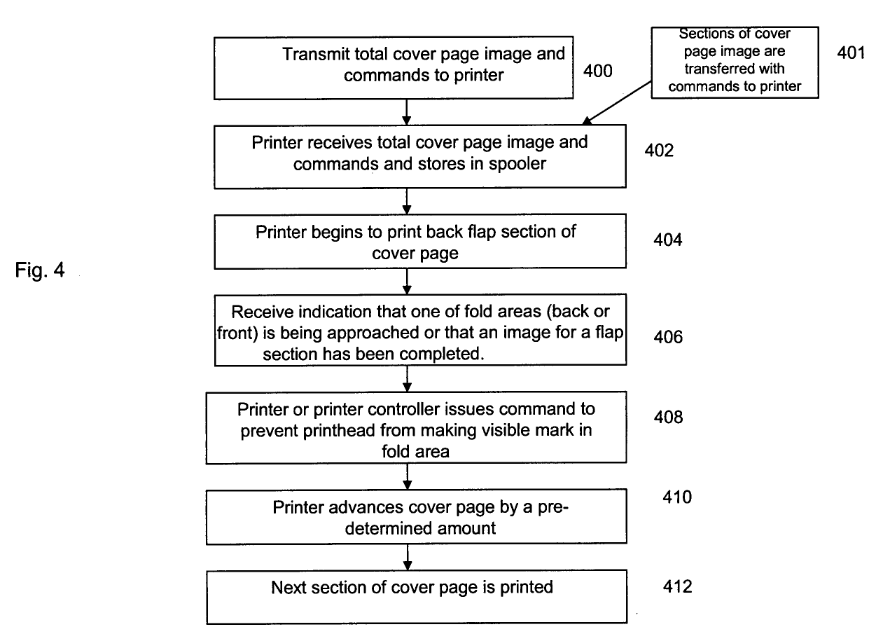

FIG. 4 illustrates a method to minimize marking or printing in fold areas of the cover page according to an embodiment of the present invention. The front fold area 222 dimensions and the back fold area 220 dimensions (e.g., width) of the cover page are dependent upon a size of the cover page. Sample cover page, back fold areas, and front fold area dimensions are shown in the table below.

| Cover Specification | Cover A | Cover B |
|---|---|---|
| Dimension tolerance | 139.7 +/− .5 mm × | 216 +/− 0.5 mm × |
| | 530 +/− 1 mm | 729.8 +/− 1 mm |
| Score line center from | 65.6 +/− 0.5 mm | 88.5 +/− 0.5 mm |
| left side | | |

As illustrated in FIG. 3(a), a create cover page screen 300 for a book or album is created. The album creation or editing software may allow for text to be entered into one of the sections of the cover page. The entry box 350 allows for entry of text and for selection of a number of text fonts, highlights, or centering options. The current section view box 352 illustrates how the entry of text looks on the back cover of the cover page for the book or album. The album creation application software, e.g., Epson Storyteller™ Publisher, selects one of the sections of the cover page and allows for insertion or placement of images into the selected section of the cover page. FIG. 3(a) illustrates operating conditions where the back cover of a cover page is selected for placement of images and/or text. FIG. 3(b) illustrates operating conditions where a front cover is selected for placement of images and/or text. This is illustrated in the section highlight area 360 of the create cover page screen 300. As illustrated in FIGS. 3(a) and 3(b), the album creation or editing application software may select images from a template of images, which are indicated by reference number 354. These images may be included in the album creation application, may be imported into the application, or may be selected from a memory on a computing device running the album creation or editing application software.

The size of the book and the cover may be determined previously when the book or album was created in the album creation application software. Under other operating conditions, the size of the cover may be selected during a create cover function of the album creation application software, e.g., Epson Storyteller™ Publisher application.

After background images, other images, and text is selected for the cover page, a final version of the cover page, e.g., the total cover page image, may be saved or stored. The total cover page image may be sent or transmitted 400 to the printer. The total cover page image may be transmitted 401 a section at a time with commands following or interspersed between the sections. The transmission or sending may be initiated by selection of a print function within the album creation application. As illustrated in FIG. 3(a), this may be the selection of a print button 356 on the right hand side of the create cover menu screen 300.

The total cover page image transmitted to the printer may include printer commands. Under other operating conditions, the printer commands may be transmitted or sent in a separate file from the total cover page image, but the printer command file may be transmitted or sent at the same time or approximately the same time as the total cover page image. The printer receives 402 the total cover page image and stores this total cover page image along with the printer commands in a buffer or memory, which may be referred to as a spooler. Under other operating conditions, the printer receives sections of the total cover page image and stores each section in the spooler. When the printer becomes available for printing, the printer begins 404 to print the requested image(s) on the back flap section of the cover page.

Under certain operating conditions, after the image(s) for the back flap section of the cover page have been printed or near the end of when the image(s) for the back flap section have been printed, the printhead approaches the back fold area 220, a command is executed by the printer to prevent the printhead from causing a perceptable or visible mark in the back fold area. In other words, the printer receives an indication 406 that one of the fold areas (e.g., back fold area 220 or front fold area 222 ) is being approached or is about to be entered. In response to either receiving an indication that the back fold area 220 is being approached or after the printing of the image for the back flap section 202 is complete, the printer (or printer controller) issues 408 a command to prevent the printhead from either 1) making any mark on the back or front fold area of the cover page or 2) making a non-visible or a light mark on the back or front fold area of the cover page.

Under certain operating conditions, the command may result in the printhead moving to the left side of the paper and to not print. Under certain operating conditions, the command may result in the printhead moving to the right side of the paper and also not to print. Under certain operating conditions, the command may result in the printhead moving to a left side or a right side of the print carriage assembly, i.e., the printhead is not above any portion of the cover page and is only above the platen. Under certain operating conditions, the command may result in the printhead moving to the center of the cover page and not printing on the cover page. Under certain operating conditions, the command may result in the printhead being placed in an area over a portion of the cover page and being instructed to print a single dot in a non-visible or slightly visible ink color. Illustratively, non-visible or slightly visible ink colors may include a yellow color, a clear ink color, or a light cyan color.

The printer or printer controller then executes or issues a command to move or advance 410 the cover page paper by a specified length. In other words, the printer may advance the paper, so that the printhead is no longer able to print in the back fold 220 or front fold 222 area. In an embodiment of the invention, the width distance of the back fold 220 or front fold 222 area may be at least one inch. In other words, for example, from the beginning of the fold area, e.g., the back fold area, the cover page paper may advanced by the printer approximately one 1 inch. Illustratively, this should correspond to 0.5 inches on both sides of a first fold line 221 in the back fold area 220. Under other operating conditions, the length or width of the advance that the paper is forwarded may be a nozzle length of one nozzle of an ink-jet printhead. Under other operating conditions, the length or width of the advance that the cover page paper is forwarded may be a head length of the printhead.

After the paper has been advanced by the specified length, and moves past the back fold area, printing 412 of a next section of the cover page is resumed. Illustratively, printing is resumed and the printing of the image(s) for the back cover of the cover page is printed.

A similar process occurs when other fold areas, e.g., the front fold area 222, is approached. The front fold area 222 is the area around the front fold line 223, or the area between the front cover 208 and the front flap 210.

FIG. 3(c) illustrates a sample fully printed cover page according to an embodiment of the present invention.

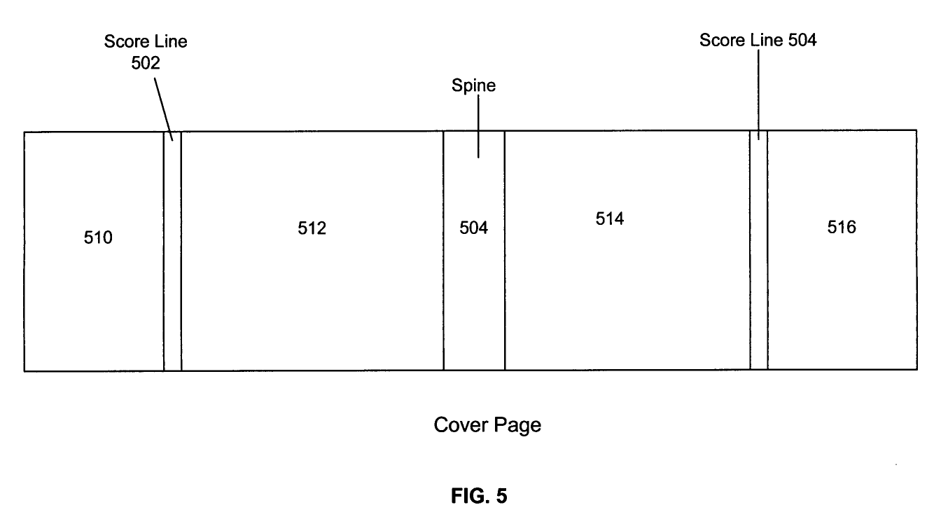

FIG. 5 illustrates a top view of scoring of a cover page according to an embodiment of the present invention. A cover page 500 includes a first score line 502, a spine 504, and a second score line 506. The cover page also includes a back flap 510, a back cover 512, a front cover 514, and a front flap 516.

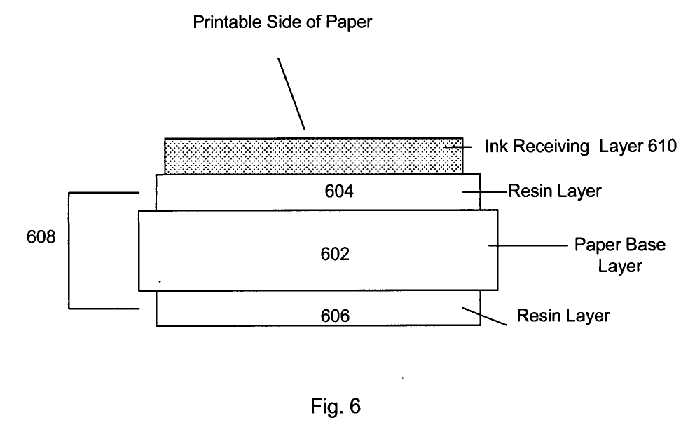

Paper utilized in high quality ink jet printing may include a plurality of layers. FIG. 6 illustrates a cross section of cover page paper utilized for high-quality ink jet printing according to an embodiment of the present invention. The overall paper may include a paper base layer 602. On a top side of the paper base layer 602, a resin layer 604 (e.g., top resin layer) may be deposited. The resin layer may include a polyethylene. A resin layer 606 may be deposited on a bottom side of the paper base layer 602. Together, the paper base layer 602, the resin layer 604, and the resin layer 606 may be referred to as resin-coated paper (RC) paper.

As illustrated in FIG. 6, an ink receiving layer 610 may be deposited on the resin layer 610. Currently, the ink receiving layer 610 maybe a silica layer, e.g., a layer made of one or more binders and a mixture of inorganic oxides or the elements silicum oxide, and oxide/hydroxides of the silicates. When a printer jets or transmits the ink to the paper printable side of the paper, the ink receiving layer 610 absorbs the transmitted or jetted ink. There are two types of ink jet papers that are utilized for high-quality ink jet printing: 1) a microporous ink jet paper and 2) a swellable ink jet paper. In the microporous ink jet paper, the ink jetted from the printhead is absorbed into the ink receiving layer 610, but the ink receiving layer does not expand. In a swellable ink jet paper, the ink jetted from the printhead of the printer is absorbed into the ink receiving layer 610, and the ink receiving layer expands slightly because of the swelling of water-soluble polymers. Kodak™ and Hewlett-Packard™ manufacture swellable ink jet photographic papers.

Because cover pages are long in length, e.g., approximately 21 or 29 inches, the cover pages need to be scored before being shipped to retail locations to consumers. In other words, a score line or a fold line needs to be made on the cover page. A fold line or score line allows the cover page to bend and be shaped around one of the covers of the album or book, e.g., the album front cover or the album back cover. Illustratively, a back score line or fold line 502 (see FIG. 5) allows the cover page to wrap from the back flap 510 to the back cover 512 and a front score line or fold line 506 (see FIG. 5) allows the cover page to wrap around from the front cover 514 to the front flap 516.

Previous scoring lines or fold lines were 1 mm in width or smaller. The width of the scoring or fold lines, the ink receiving layer composition, and the pressure when forming fold lines or score lines all separately or individually may contribute to cracking or tearing of the cover page paper. Accordingly, cover pages, which are high quality photographic products, would crack and this would degrade the appearance of the cover page and album or book owner's satisfaction. When a cover page is torn, ripped, or cracked, the ink receiving layer 610 and the resin layer 604 of the cover page developed the rip, tear or crack. Generally, the paper base layer 602 was not damaged or injured.

The ripping, tearing, or cracking of the cover page paper, which may occur during scoring of the paper, may be minimized by making the ink receiving layer 610 with a new material. Instead of using silica coating, the ink receiving layer 610 of the cover page may be made of one or more binders and a mixture of different water insoluble, inorganic oxides of th elements aluminum, and oxides/hydroxides of the element aluminum. Photo paper having an ink receiving layer including one or more binders and a mixture of different water insoluble, inorganic oxides of the elements aluminum, and oxides/hydroxides of the element aluminum may be be purchased from Dmax Imaging, Inc. Tearing, ripping, and cracking of the cover page paper during scoring is minimized when the ink jet layer of the cover page paper is made of Al₂O₃.

The ripping, tearing, or cracking of the cover page paper may also be minimized by increasing the width of the scoring lines or fold lines. An increase of the width of the scoring lines or fold lines to more than 1.5 mm results in the cover page paper having minimal or no ripping, tearing or cracking. The increase of the width of the scoring lines or the fold lines to more than 1.5 mm also results in a better fit around the junction between the flaps and covers, e.g., the back flap 510/back cover 512 and the front flap 516/front cover 514.

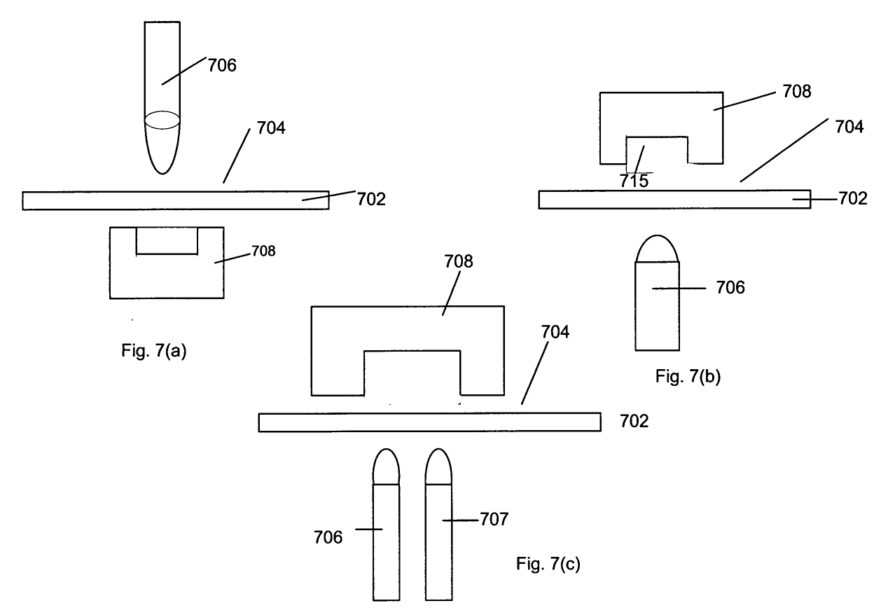

FIGS. 7(a), 7(b), and 7(c) illustrates elements utilized in creating score lines or fold lines according to an embodiment of the present invention. Under certain operating conditions, as illustrated in FIG. 7(a), a male scoring element 706, which is located above the printable side 704 of the paper 702, is moved towards the paper 702, as indicated by arrow 710. The paper 702 presses down against the female scoring element 708 and the paper is depressed to create the score line or fold line. In embodiments of the invention, the width of the male scoring element 706 is 1.5 millimeters. In embodiments of the invention, the width of the male scoring element 706 is greater than 1.5 millimeters.

FIG. 7(b) an embodiment of the invention where the female scoring element 708 is positioned above the printable surface 704 of the cover page paper 702 and the male scoring element 706 is positioned below the cover page paper 702. In this embodiment of the invention, the female scoring element 708 moves toward the paper 702. The paper 702 is pressed down to the male scoring element 706. The depressing of the female scoring element 708 onto the paper 702 and against the male scoring element 706 results in formation of the scoring line or fold line. In embodiments of the invention, the width of the cutout 715 in the female scoring element 708 is 1.5 mm or greater.

FIG. 7(c) illustrates utilization of two or dual male scoring elements 706 and 707 in combination with the female scoring element 708 and the paper 702. In embodiments of the invention, the width from outside edge of a first male scoring element 706 to an outside edge of the second male scoring element 707 is 1.5 mm or greater. The use of dual or two male scoring elements 706 and 707 may result in a lower pressure being placed on the paper and this may lead to a lower occurrence of rips, tears, or cracks in the cover page paper.

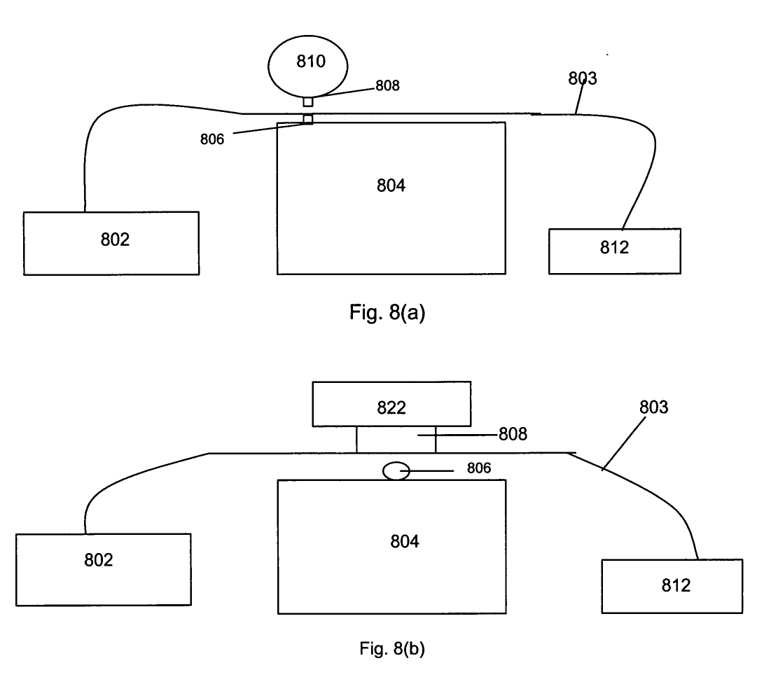

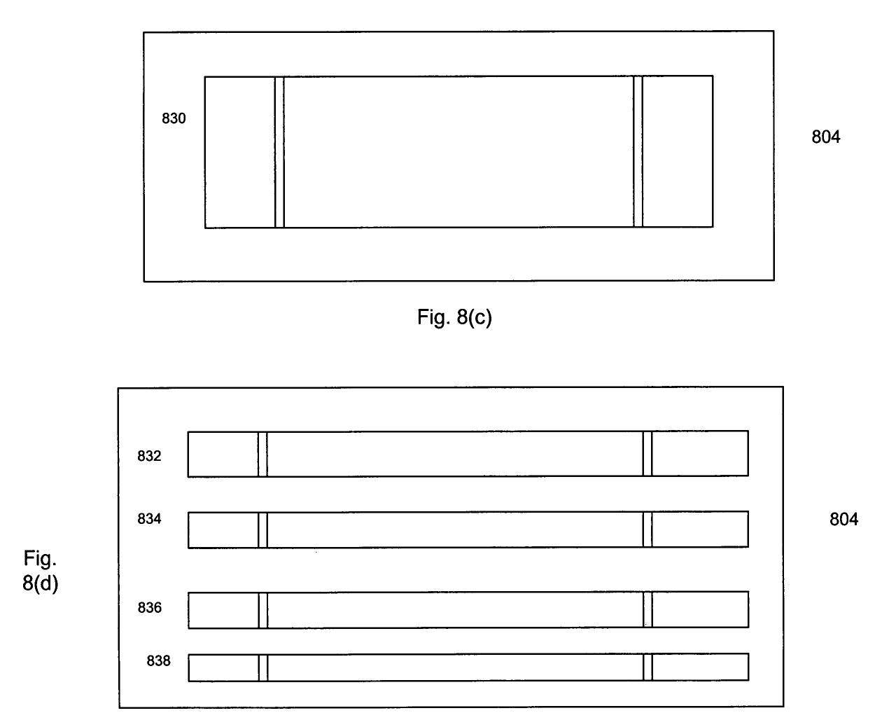

FIGS. 8(a) and 8(b) illustrate side views of two systems for scoring photographic paper according to an embodiment of the present invention. FIG. 8(a) illustrates a roll scoring system according to an embodiment of the present invention. The roll scoring system 800 includes a paper receiving section 802, a system table 804 including a male scoring element 806, a roller 810 including a female scoring element 808, and a paper input device 812. The paper 803 is fed from the paper input device 812 over the system table 804 by a series of rollers (not shown). When a score line is to be made on paper input from the paper input device 812, the roller 810 including the female scoring element 808 is pressed against the paper and consequently the male scoring element 806. The pressing results in creation of a score line or a fold line. The paper is then transported to the paper receiving section 802. In embodiments of the invention, a cutting device (not shown) may cut the paper to one of the cover page sizes before or after the roller 810, female scoring element 808, and male scoring element 806 create the fold line or score line on the paper. Utilization of the roll scoring device requires precise synchronization of the roller 810 with the paper and also the rollers of the roll scoring system. If slippage occurs in the roller 810, the score lines may not be created in the correct location and/or the paper not being cut in the correct location.

FIG. 8(b) illustrates use of a die cutter scoring system according to an embodiment of the present invention. The die cutter scoring system 820 includes a paper receiving section 802, a system table 804 including a male scoring element 806, a die 822 including a female scoring element 808, the paper 803, and the paper input device 812. In the embodiment of the invention illustrated in FIG. 8(b), the paper is input from the paper input device 812 and transported across the system table 804 by a set of rollers (not shown). At specified lengths of the paper, e.g., where the fold lines or score lines are to be created, the die 822 including the female scoring element is pressed against the paper 803. This results in the paper 803 being pressed against the male scoring element 806 on the system table 804 and a score line or a fold line being created on the photographic paper. The photographic paper 803 is then transferred or transported to the paper receiving section 802 with score or fold lines.

FIG. 8(c) illustrates one page 830 resting on a system table 804 after having score lines generated and FIG. 8(d) illustrates a plurality of pages 832 834 836 838 resting on a system table 804 after having score lines generated. In embodiments of the invention only one page may be scored at a time by the roll scoring system 800 or die cutter scoring system 820. In embodiments of the invention, multiple cover page papers 832 834 836 and 838 may be scored simultaneously (or at the same time). Simultaneous scoring results in increased manufacturing efficiency, e.g., more cover page paper may be scored.

An additional method of decreasing rips, cracks, or tears of cover page papers during scoring is to reduce the pressure on the cover page paper that the die 822 or the roller 810 exerts on the cover page paper.

Transporting or shipping of cover pager paper may also create a problem. The length of the cover page paper is long (21 inches or 29 inches). If the paper is folded during shipment, the paper becomes bent, and printing problems may occur because the degree of bend or the amount the paper is bent (in terms of inches) may be greater than the platen gap. This may result in the paper, when inserted into the printer, rubbing against the printhead. If the cover page paper is not folded, then the packaging for the cover page paper will be quite long and will be difficult to transport and to stock on store shelves. If the cover page paper is packaged with other materials, e.g., the Epson Storyteller™ CD initial package includes two sheets of the cover page paper, the CD, installation instructions, an album, and a user's guide, many voids are created and must be packed with filling material, which results in cost increases in the packaging of the cover page paper.

FIG. 9 illustrates packaging of a plurality of sheets of cover page paper according to an embodiment of the present invention. The outer package or shipping package 900 includes a plastic protective sheet 902, a first blank cover page 904, a second blank cover page 906, and a packing support 908. The packing support may include a rectangular portion 910 and a semi-circular portion 912. In an embodiment of the invention, instead of a semi-circular portion 912, there may be a semi-hexagonal portion or a semi-oval portion of the packing support 908. The semi-circular portion 912 of the packing support 908 may be attached to the rectangular or box-shaped portion. In other embodiments of the invention, the box-shaped portion 910 may be adhered to the semi-circular portion 912. In an embodiment of the invention, the box-shaped portion 910 may be attached to the semi-circular portion 912 at side edges 930 and 932. In other embodiments of the invention, the box-shaped portion 910 may be attached to the semi-circular portion 912 at one of the side edges 930 or 932. FIG. 9 illustrates an embodiment where the box-shaped portion 910 is connected to the semi-circular portion 912 at a single point 930.

As illustrated in FIG. 9, the semi-circular portion 912 provides support for the curving of the cover page photographic paper to allow the long cover page photographic paper to be stored in a regular size or smaller size shipping box. The box-shaped portion 910 of the cover page support 908 also provides support for the cover page paper or cover page photographic paper. Because the semi-circular support portion 912 is curved, no folds or creases in the paper are created and ripping, tearing, and cracking of the cover page photographic paper is also minimized. In order to increase efficiency, the rectangular box 910 may include, inside the box-shaped support portion 910, manuals, CDs, promotions, coupons, etc. According, the rectangular portion 910 of the support 908 may serve a dual purpose of providing support for the cover page paper as well as being a storage area for publications, promotions, and/or software.

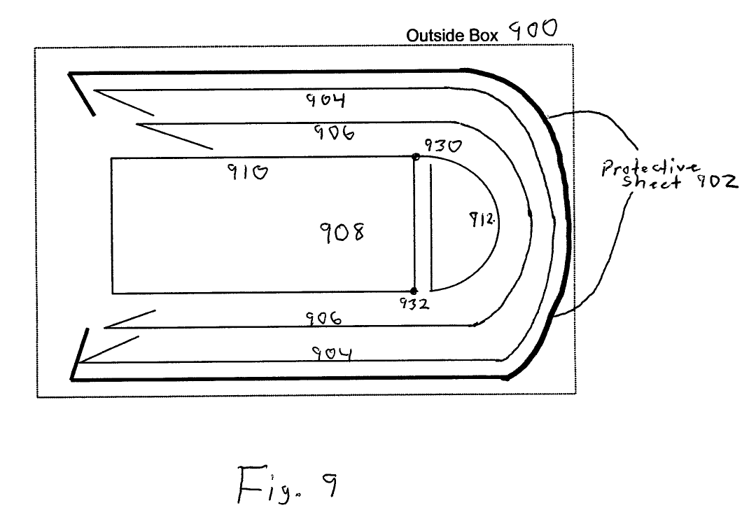

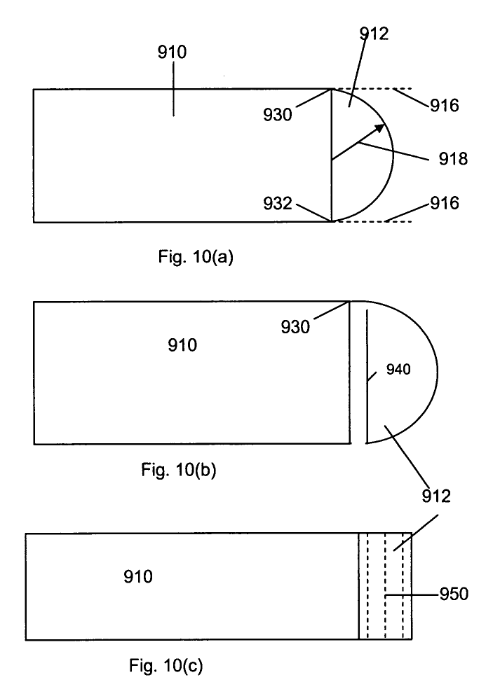

FIG. 10(a) illustrates a side view of a cover page support portion according to an embodiment of the present invention. In the embodiment of the invention illustrated in FIG. 10(b), the semi-circular support portion 912 is attached to the box-shaped portion at both sides edges 930 and 932. The semi-circular portion 912 may have a set radius, as illustrated by arrow 918. In an embodiment of the invention, a radius of 25 mm for the semi-circular portion 912 provides enough curvature support to allow the paper to cover page paper to curve around the semi-circular support portion 912 but not enough to create pressure and to crease or break the cover page paper. In other embodiments of the invention, a radius of between 10 mm and 50 mm for the semi-circular portion 912 may provide the necessary support for the cover page photographic paper. FIG. 10(b) illustrates a side view of a cover page support portion where a semi-circular portion is only connected to a cover page support portion 908 at a single side edge 930. Illustratively, the semi-circular portion 912 may be connected to the box-shaped portion 910 at a single side 930 or across a single line of points. The semi-circular portion 912 may include a support flange 940 that may not touch the box-shaped portion 910 of the cover page support portion 908. This support flange 940 provides additional support for the semi-circular portion 912 and the cover page photographic paper. As illustrated in FIG. 10(b), the support flange 940 may rest in a position that is parallel to a face or side of the box-shaped portion 910.

The cover page support portion 908 may be made of a rigid material. The rigid material may be a plastic material or the rigid material may such as cardboard. The semi-circular portion 912 may have perforated lines scored or cut-through the cardboard to allow for additional flexibility and curving of the cardboard. FIG. 10(c) illustrates a top view of a cover page support portion including perforated lines in the semi-circular support portion according to an embodiment of the present invention. As illustrated in FIG. 10(c), the perforated lines 950 may run, when viewing from the top, from a left side of a top face to a right side of the top face. In embodiments of the invention, one perforated line may be present on the semi-circular support portion 912. In embodiments of the invention, a plurality of perforated lines may be scored or made on the semi-circular support portion 912.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A method of printing on a cover page paper, comprising:
receiving an indication that a printhead has reached a fold area on the cover page paper;
moving the printhead in response to the receiving the indication that the printhead has reached the fold area;
forwarding the cover page paper by a predetermined amount; and
resuming printing, by the printhead, after the forwarding of the cover page paper.

2. The method of claim 1, wherein the printhead is moved to a left side of the paper.

3. The method of claim 1, wherein the printhead is moved to a right side of the paper.

4. The method of claim 1, wherein the pre-determined amount the cover page paper is forwarded is a nozzle length of one nozzle of an ink-jet printhead.

5. The method of claim 1, wherein the pre-determined amount the cover page paper is forwarded is a head length of the printhead.

6. The method of claim 1, further including printing a single dot on the cover page paper after moving the printhead.

7. The method of claim 6, wherein the single dot is printed in a yellow ink.

8. The method of claim 6, wherein the single dot is printed in a clear ink.

9. The method of claim 6, wherein the single dot is printed in a light cyan ink.

10. The method of claim 1, further including printing a single dot outside a width of the cover page after moving the printhead to a cover page paper.

11. A method of scoring a cover page photographic paper, comprising:
moving the cover page photographic paper in between a male scoring element and a female scoring element; and
moving the female scoring element toward the paper and the male scoring element to create a fold line, the fold line having at least a 1.5 mm width.

12. The method of claim 11, wherein the female scoring element and the male scoring elements are part of a roll scoring system.

13. The method of claim 1 1, wherein the female scoring element and the male scoring element are part of a die cutting scoring system.

14. The method of claim 11, further including a second male scoring element, which is utilized to create the fold line having the at least 1.5 mm width.

15. A method of packing cover page paper, comprising:
placing a cover page support made of a rigid material along a surface;
inserting at least one cover page sheet around the cover page support; and
placing a protective sheet around the at least one cover page sheet and the cover page support.

16. The method of claim 15, further including placing the protective sheet, the at least one cover page sheet, and the cover page support in a shipping package.

17. The method of claim 15, wherein the cover page support includes a box-shaped portion and a semi-circular portion, and the semi-circular portion of the cover page support provides support for bending of the at least one cover page sheet to allow the cover page sheet to fit into a shipping package.

18. The method of claim 17, wherein the semi-circular portion of the cover page support has a radius of at least 25 mm.

19. The method of claim 17, wherein the cover page support connects to the box-shaped portion at two side edges.

20. The method of claim 17, wherein the cover page support connects to the box-shaped portion at a single side edge.
